(19) United States
(12) Patent Application Publication
(10) Pub. No.: US 2008/0005049 A1
(43) Pub. Date: Jan. 3, 2008

(54) Collecting and Processing Data

(76) Inventors: Steven James Wheeler, Hereford (GB); Anthony Molloy, Birmingham (GB)

Correspondence Address: KING & SCHICKLI, PLLC, 247 NORTH BROADWAY, LEXINGTON, KY, 40507, US

(21) Appl. No.: 10/592,625

(22) PCT Filed: Mar. 9, 2005
(86) PCT No.: PCT/GB05/00897

§ 371 Date: Jun. 25, 2007

(30) Foreign Application Priority Data
Mar. 10, 2004 (GB) 0405348.4
Dec. 23, 2004 (GB) 0428144.0

(51) Int. Cl. G06F 15/18

(52) U.S. Cl. 706/19

(57) ABSTRACT

A system for collecting and processing data includes a device (102) for producing output data describing deformation of a surface (104), which may be part of a golf driving mat. The system also includes a device (206) for obtaining (402) data describing deformation of the surface over a period of time. The system can process the obtained data as a time series to produce (406) data describing characteristics of the deformation, and/or classify (408) the obtained data according to one or more of a set of data describing characteristics of deformation of the surface.

The present invention relates to collecting and processing data.

There are at least two physical methods that can be used to analyse the dynamic movement of an object whilst in contact with a surface: tactile systems that are in contact with the object in some way and vision or monitoring systems. For example, for a comprehensive examination of a golf swing these two existing systems have been used simultaneously to maximise and correlate the data captured for the dynamic activity. Hosea T. M., Gatt C. J., Galli K. M., Langrana N. A., Zawadsky J. P. (1990). Biomechanical analysis of the golfer's back. Science and Golf (Edited by A. J. Cochran), (London: E-FN Spon) pp. 43-48 analysed the effect of dynamic activity affecting the lumber spine in professional and amateur golfers.

To carry out this dynamic analysis, reflective markers were placed on several selected segments on the spinal cord, with four synchronized cameras placed around the subject to allow stereoscopic visualisation of all the data points. Also, myoelectric activity of the golfers back was determined using a tactile electromyography (EMG) technique. Foot pressure profiles have also been recorded throughout the golf swing. Wallace E. S., Grimshaw P. N., Ashford R. L. (1994), “Discrete pressure profiles of the feet and weight transfer patterns during the golf swing”, Science and Golf II: Proceedings of the World Scientific Congress of Golf (Edited by M. R. Farrally and A. J Cochran), pp. 26-32, used piezoelectric transducers to determine pressures at eleven specific positions under the foot, in conjunction with a three dimensional video capture technique. Also, Barrentine S. W., Fleisig G. S. and Johnson H. (1994), “Ground reaction forces and torques of professional and amateur golfers”, Science and Golf II: Proceedings of the World Scientific Congress of Golf (Edited by M. R. Farrally and A. J Cochran), pp. 33-39, used two force platforms covered with artificial grass to collect ground reaction forces for the left and right feet, in conjunction with high speed motion analysis to correlate the temporal aspects of the club swing with the force platform data. If a tactile sensing system can analyse and classify the collected data correctly and be correlated and verified by the collected data received by a vision system, then it is sufficient to suggest that a tactile system could be effective enough as a stand alone system to classify the dynamic correctly. If a tactile system is proved to be effective enough without the use of a vision system, then the synchronisation of the data capture, complexity of image filtering and processing is eliminated from the capture and analysis of the dynamic activity. This elimination of a vision system would improve the mobility and complexity of the analysis and classification process. Tactile sensing systems are touch sensors that can measure or indicate the presence or absence of a contacting stimulus such as temperature, mechanical, or electrical energy sources. For the purpose of analysing foot to ground pressure patterns the most common type of tactile sensing system is an array type sensing system, as in Wallace E. S., Graham D., Bleakley E. W. (1990), “Foot-to-ground pressure patterns during the golf drive: a case study involving a low handicap player and a high handicap player”, Science and Golf (Edited by A. J. Cochran), which describes such a system comprising of two force plates, each with 2048 sensors in an active area of 193×412 mm. The output of this system was either an image of the pressure distribution of the foot in contact with the surface, or numerical force magnitudes of the left and right feet. However, these measured and recorded values offer no meaningful information on the dynamic activity on the surface, and the output of these systems typically ends at this point.

Neural network techniques have previously been applied to digital input data to display an output relating to real time data capture, see Worth A. J., Spencer R. R. (1989), “A neural network for tactile sensing: The Hertzian contact problem”, Proceedings of the International Joint Conference on Neural Networks, June (Washington D.C.), Vol. 1, pp. 267-274. However, these are said to behave statically as they only refer to one output at each point in time. These conventional methods can involve non-linear transformations of the input into output that facilitates gradient search methods, such as scaled conjugate gradient, or steepest descent training method. Alternatively, inverse matrix multiplication techniques or single layer perceptron (SLP) neural networks perform a linear transformation from the input to the output that can use a pseudo inverse least mean square training method, or single layer back propagation gradient search method.

These existing methods are classified as “static” systems as they do not utilise a time series data set to interpret a discrete singular output. The majority of these existing static sensing systems could be classified as one of the
1) Single point force sensors. These are typically deployed in singular or multi axis points. This type of device only has the ability to measure a force point of contact in proximity with the measuring element. The measurements of these types of devices are characterised by the sampling rate of the device. Thus, a discrete magnitude is assigned to a unique sample in the time sequence, indicating a “static” system.
2) The deployment of force sensors near the corners of a sensing surface. This is then used as a force plate that can determine the position and magnitude of a force centre of pressure on the surface, through the use of a proportionality algorithm. These systems are only designed to measure “static” forces.
3) Force array surfaces. These systems consist of a matrix configuration of force sensors under the sensing surface. The data capture from each unique sensing element occurs through the use of multiplexing many electrical connections. Each unique sensing element measures only the stimulating force in close proximity. Thus, the interpretation of the surface deformation is dependant upon the spacing between sensors in the sensing matrix, which has limitations due to the physical density of sensors that can be deployed in one space. Moreover, this device only measures at discrete time points, and no subsequent analysis is carried out. Thus, the system is said to behave in a “static” manner.

Embodiments of the present invention are intended to mitigate the various shortcomings mentioned above and to provide improvements over conventional sensing approaches. Specific embodiments are intended to allow the movement of the body (e.g. a human body) through kinematic movement (e.g. a golf swing) to be precisely recorded/analysed, leading to the appropriate training techniques (e.g. coaching) being adopted to modify the movement of the body. This information can further be used to compare kinematic movements (e.g. a golf swing) with other kinematic movement over time (e.g. other golfers' swings) and/or the same or other kinematic movements over time (e.g. previous swings performed by the same golfer).

According to one aspect of the present invention there is provided a method of processing data including steps of:

obtaining data describing deformation of a surface over a period of time, and

processing the obtained data as a time series to:
produce characterisation data describing characteristics of the deformation of the surface over a period of time, and/or
classify the obtained data according to one or more of a set of characterisation data describing characteristics of deformation of the surface over a period of time.

The step of producing characterisation data may include a step of calculating coefficients for an equation that substantially reproduces the obtained data. Data describing the coefficients can then be stored for use in the classification step.

The step of classifying the obtained data can include comparing the obtained data with a set of (previously produced) characterisation data and selecting the member or members of the set that most closely matches the obtained data. The comparison may be performed using linear or non linear neural network classification techniques, or a divergence method, or a linear matrix inverse method. For example, the classification step may include inputting data to be analysed into a neural network that has been trained to classify data according to one or more of a set of data describing characteristics of the kinematical movement or deformation of the surface.

The classifying step may include a linear classification process when there is a linear relationship between the obtained data (that is used as an input for the linear process) and an output of the linear process. Alternatively, a non-linear classification process may be used when there is a non-linear relationship between the obtained (input) data and an output of the non-linear process. Examples of linear classification processes include using generalised linear models (GLM) or single layer perceptron (SLP) neural networks for regressive analysis. These compare the obtained data with one of the set of characterisation or input data to produce a correlation indication and then apply an activation function to the correlation indication to produce a classification or regressive output. Examples of non-linear classification processes include using a multi layer perceptron (MLP) network (or Radial Basis Function network, or a Baysian technique) to compare the obtained data with one of the set of characterisation data to produce a correlation indication and then applying an activation function to the correlation indication to produce a classification output.

The method may further include a step of identifying a portion of the obtained data to be analysed, where the data to be analysed represents a time period during which there were changes in the surface deformation. The obtained data will typically represent the outputs of a plurality of sensors positioned adjacent to the surface. The identified data may represent the performance of an action such as a sporting activity, e.g. a golf swing. A portion of the obtained data to be analysed may be identified using a crude filtering method to eliminate small changes in the curves profile, and a windowing technique that searches for + to − and − to + gradient changes that are greater than two times the standard deviation of the data, and uses the greatest of each of the + to − and − to + changes found to define the open and close points of the data window.

The obtained data typically represents forces and/or loads on the surface that would cause the surface to deform as described by the data. The method may produce data describing a position, stance, movement(s) and/or any dynamic behaviour of a (typically human, but could be any object or animal) body acting on the surface.

The method can further include a step of producing an output representing the result of the classification step. The characterisation data can represent a “target” for data in that class, e.g. it can represent deformation of the surface resulting from a professional golfer performing a certain type of golf swing that a user wishes to emulate. The output may include a comparison of data derived from the obtained data with data derived from the characterisation data that classified the obtained data. For example, the obtained data may relate to distribution of mass of a person on the surface. The output may include a representation of a target stance and a representation of a stance of the user derived from the obtained data. The output may include a representation of target distribution of mass and a representation of distribution of mass of the user derived from the obtained data. The representations of the output may be divided according to time/events, e.g. key points of a golf swing.

According to another aspect of the present invention there is provided a computer program product comprising:

a computer usable medium having computer readable program code and computer readable system code embodied on said medium for processing data, said computer program product including:

computer program code means, when the program code is loaded, to make the computer execute a procedure to:

obtain data describing deformation of a plurality of discrete points of a surface over a period of time, and

process the obtained data as a time series to:
produce characterisation data describing characteristics of the deformation of the surface over a period of time, and/or

classify the obtained data according to one or more of a set of characterisation data describing characteristics of deformation of the surface over a period of time.

According to another of the present invention there is provided a system for collecting and processing data, the system including:

a device for producing output data describing deformation of a surface;

a device for obtaining data describing deformation of discrete points of the surface over a period of time, and a device configured to process the obtained data as a time series to:
produce characterisation data describing characteristics of the deformation of the surface over a period of time, and/or
classify the obtained data according to one or more of a set of characterisation data describing characteristics of deformation of the surface over a period of time.

The device for producing the characterisation data may include a plurality of sensors located adjacent to the surface. The sensors may sense changes including changes in force, pressure strain, capacitance, resistance inductance and/or optical characteristics, which can transform mechanical deformation in some way into an electrical output. The device for producing the characterisation data may further include one or more devices for amplifying and/or filtering the outputs of the sensors.

In one embodiment four groups of the sensors are used, the sensor groups being intended to sense stimuli from a ball area of a first foot, a heel area of the first foot, a ball area of a second foot and a heel area of the second foot, respectively.

The positions and/or the number of the sensors may be selected such that the output of none of the said sensors has an unduly dominant influence on the calculations performed by the system. The positions/number of the sensors with respect to the surface can be selected by calculating a cost function value describing the accuracy of each of the sensors in sensing deformation of the surface, the cost function involving values representing the number and/or locations of the sensors and properties of the surface, and selecting the locations of the sensors in accordance with the resulting best cost function values. Determination of the best cost function values may be achieved using genetic algorithm techniques. The cost function may involve the Navier Model.

The device for producing data may include the surface, which may be formed of a deformable, resilient material such as a metal/alloy, e.g. steel, which can have low levels of hysteresis. The device for producing data may further include a housing for the sensors and/or the surface. A covering may be fitted on top of the surface to alter its appearance and/or texture.

The system may further include a device for simulating one or more loads produced by other bodies on the surface.

According to yet another aspect of the invention there is provided apparatus for processing data including:

a device for obtaining data describing deformation of discrete points of a surface over a period of time, and

a device configured to process the obtained data as a time series to:
produce characterisation data describing characteristics of the deformation of the surface over a period of time, and/or
classify the obtained data according to one or more of a set of data describing characteristics of deformation of the surface over a period of time.

According to a further aspect of the present invention there is provided a device for producing output data describing deformation of a surface suitable for use in connection with data processing apparatus substantially as described herein. According to another aspect of the invention there is provided a method of determining positions and/or the number of sensors in a data collection device such that the output of no single one of the sensors has an unduly dominant influence on the calculations performed by a system using the collected data substantially as described herein.

According to another aspect of the invention there is provided a method of training a neural network to classify data describing deformation of a surface substantially as described herein. The method may include steps of: obtaining a set of data describing deformation of a plurality of discrete points of a surface over a period of time; training a neural network to identify data that corresponds to surface deformation having certain characteristics, and storing the neural network in storage means of a computer or on a computer-readable medium. According to yet another aspect of the invention there is provided a neural network system trained to classify data describing deformation of a surface substantially as described herein.

According to another aspect of the present invention there is provided (sport) training apparatus including a device for producing output data describing deformation of a plurality of discrete points of a surface and/or a data processing device substantially as described herein.

Examples of the system can be considered to be dynamic interpretation systems because they can interpret a result from a transient observation in a selected time window, such as during a golf swing. The combination of electrical inputs can be manipulated as a unique data set, and not just a simple sum of electrical inputs as in conventional approaches. However, a sum of electrical inputs through an observed time space can be used to generate various feature characteristics relating to the dynamic behaviour on the surface that can then be classified. Classification methods can be applied to discriminate loading conditions like GLM, MLP, or K nearest neighbour methods. The change in voltage from an initial sensor datum may be calculated for each individual sensor so that the system can deal more robustly with changes, such as a change in temperature. The trained matrix may be used to form a load distribution in the SLP case and multiplies through each vector of sensor inputs for each individual time sample.

A time series method is used in specific embodiments to manipulate and characterise time series patterns in the time or frequency domain, over the observed time space. In addition to the observation of movement of human mass through kinematic movement, embodiments of the invention relating to analysis of golfing activities allow for the measurement of club head velocity. It is possible to evaluate the point of maximum velocity and time of the peak ground reaction force, which can be compared with the time at the point of contact of the ball. This can be used, for example, as a very powerful tool for teaching low handicap golfers, who can hit the ball straight, but want the ball to go further. The point of peak velocity of the club head should normally coincide with the point of contact with the ball. Specific embodiments can be used to provide substantially real-time feedback about the movement of human mass through kinematic movement on the sensing surface.

Whilst the invention has been described above, it extends to any inventive combination of the features set out above or in the following description.

The invention may be performed in various ways, and, by way of example only, embodiments thereof will now be described, reference being made to the accompanying drawings, in which:

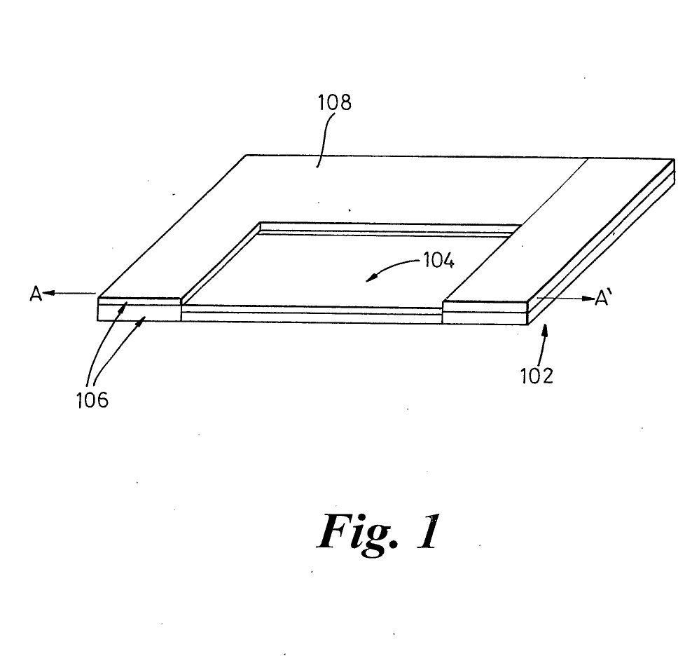

FIG. 1 is a perspective view of a mat device that is part of an example of the system;

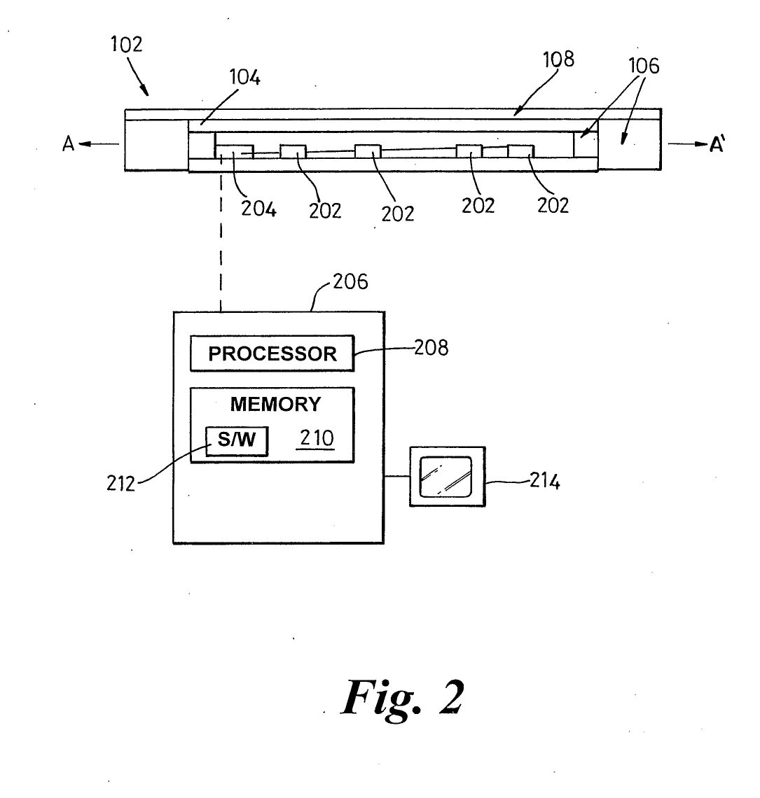

FIG. 2 illustrates schematically a section through line A-A′ of the mat of FIG. 1 and a computer in communication with components of the mat;

FIG. 3 is a graph showing example positions of sensors in the mat;

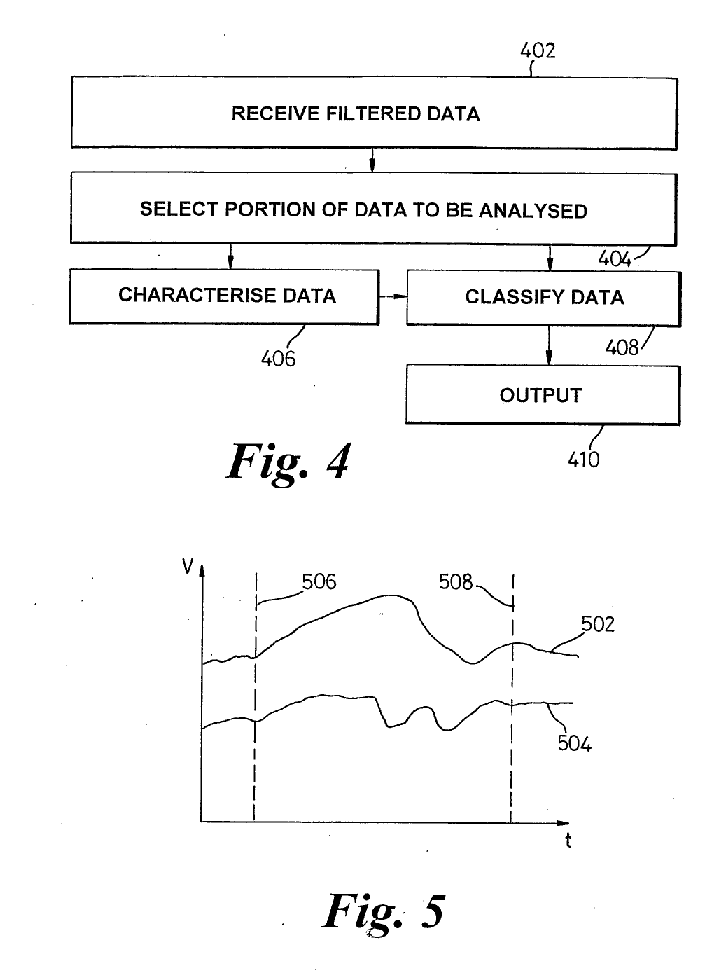

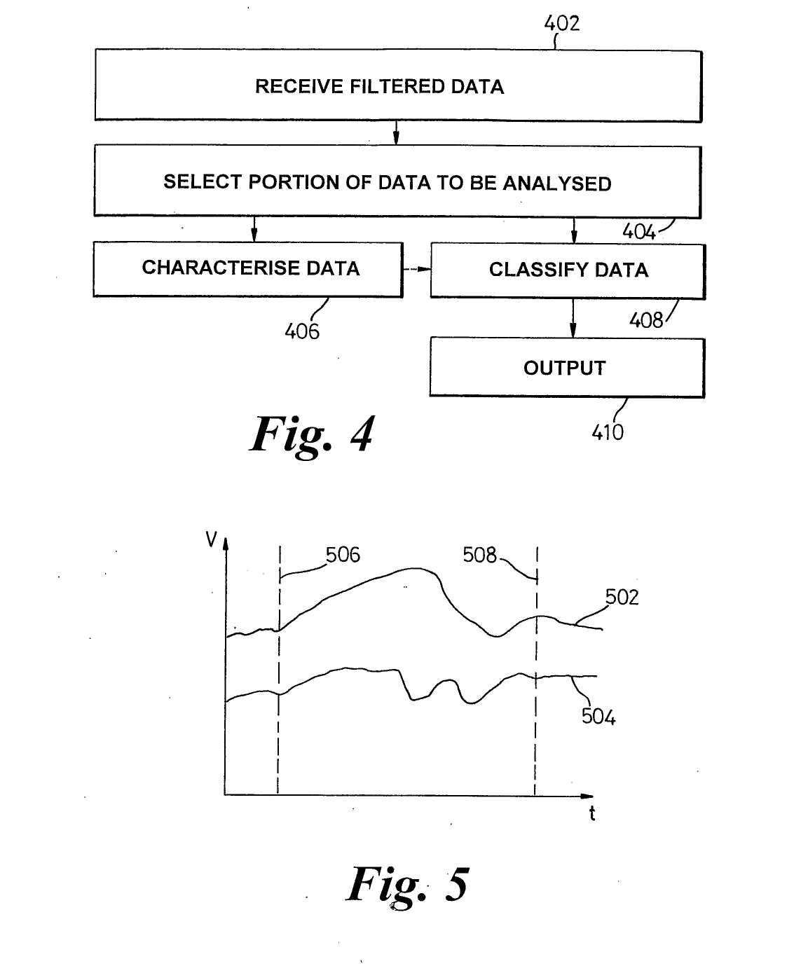

FIG. 4 illustrates schematically steps that can be performed by the computer of FIG. 2;

FIG. 5 is a graph showing example data obtained using the sensors;

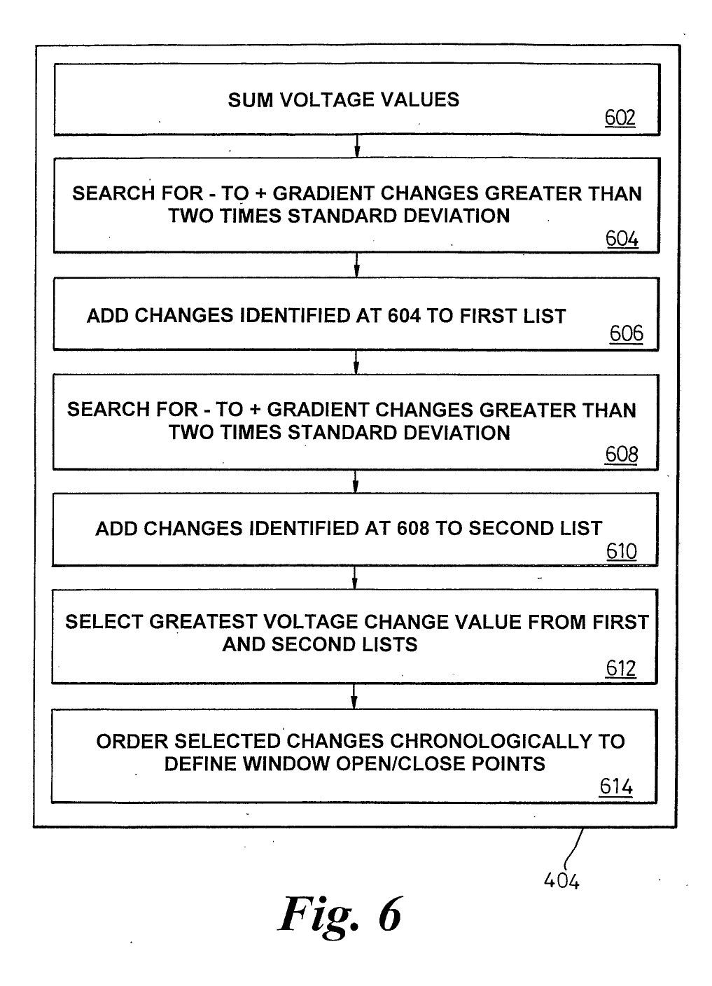

FIG. 6 illustrates schematically steps used to select a portion of the data of FIG. 5;

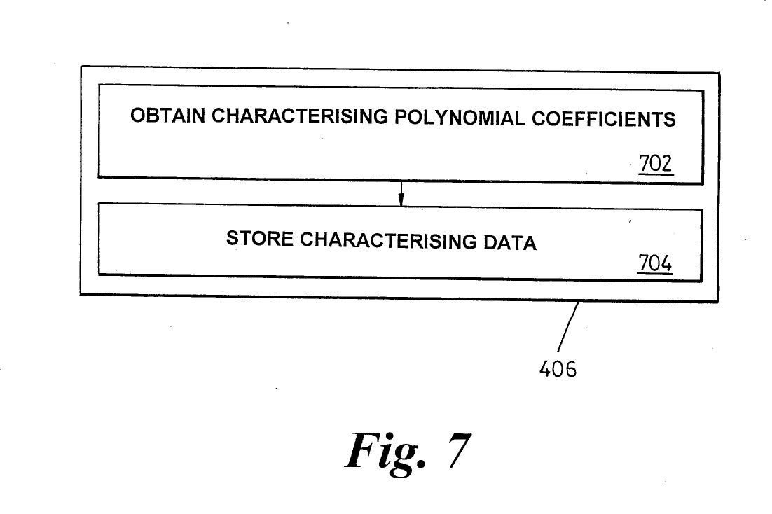

FIG. 7 illustrates schematically steps involved in a characterisation process performed on the data by the system;

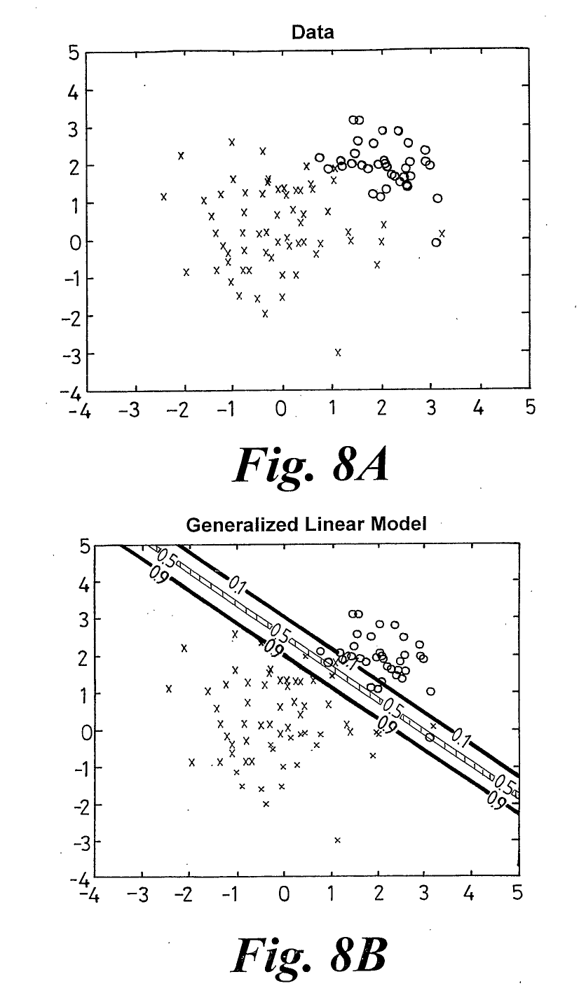

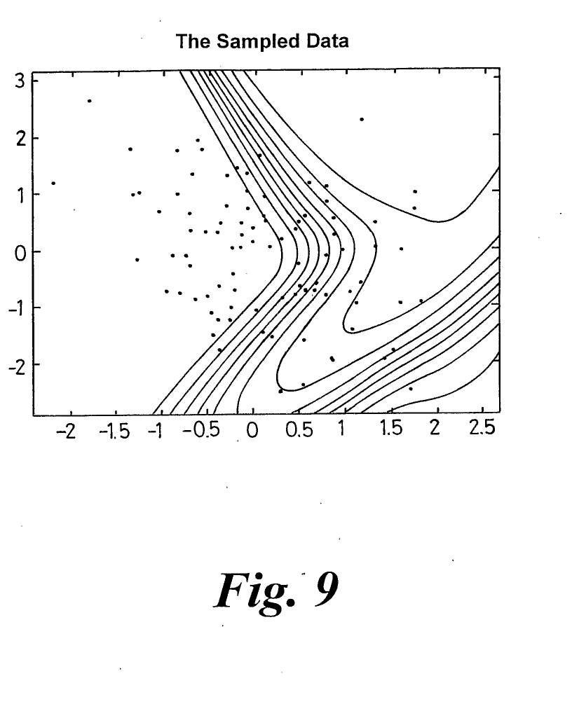

FIGS. 8A and 8B illustrate examples of two data sets to be classified by a classification process performed on the data by the system; FIG. 9 illustrates another example of a data set to be classified;

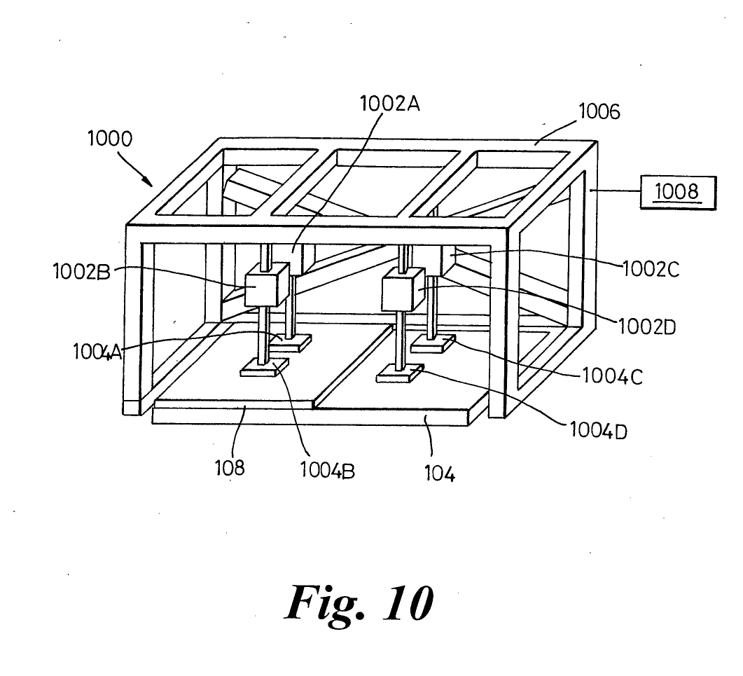

FIG. 10 is a perspective view of a device that can be used to obtaining training data for the system;

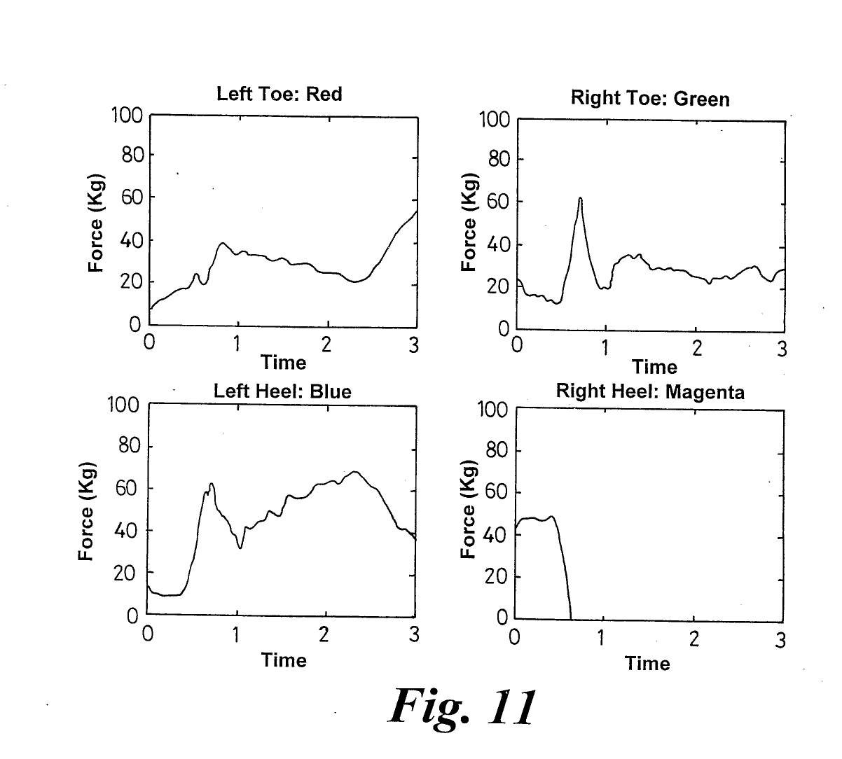

FIG. 11 shows four graphs representing sensor data relating to the force distribution at the toes and heels of the two feet of a professional golf player;

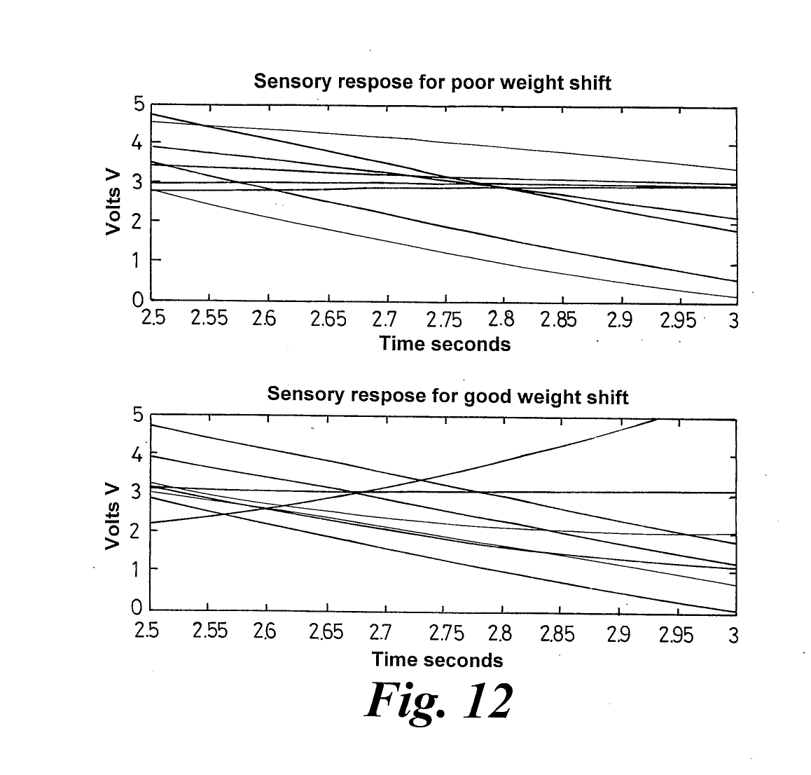

FIG. 12 shows graphs demonstrating time series data for a downswing golf shot for use in a characterisation process;

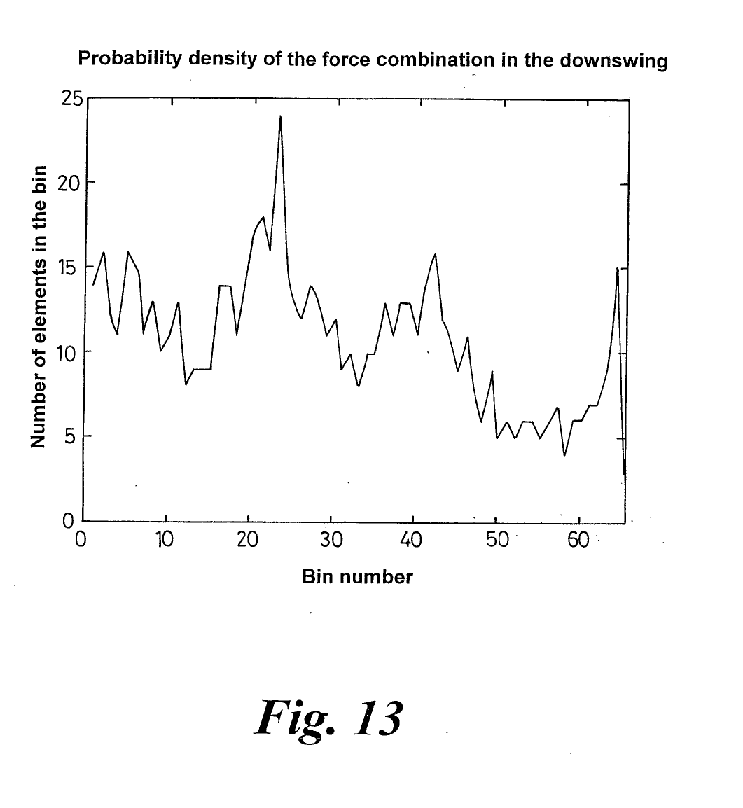

FIG. 13 is a graph illustrating the combination of the forces shown in the four graphs of FIG. 11;

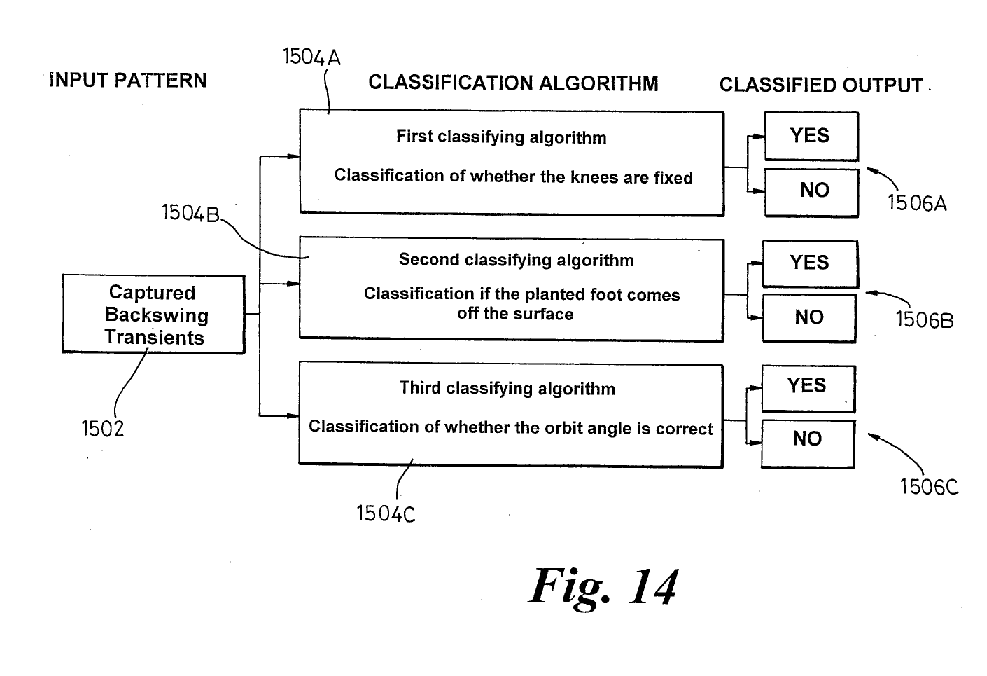

FIG. 14 illustrates schematically steps involved in an example of the classification process, and

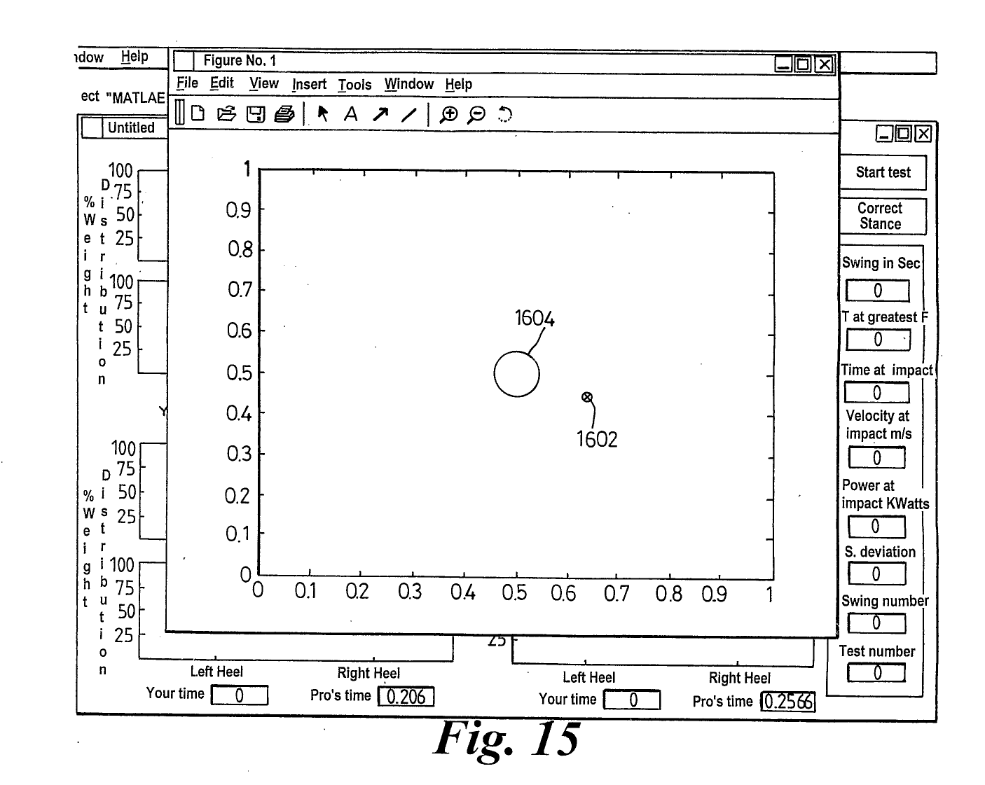

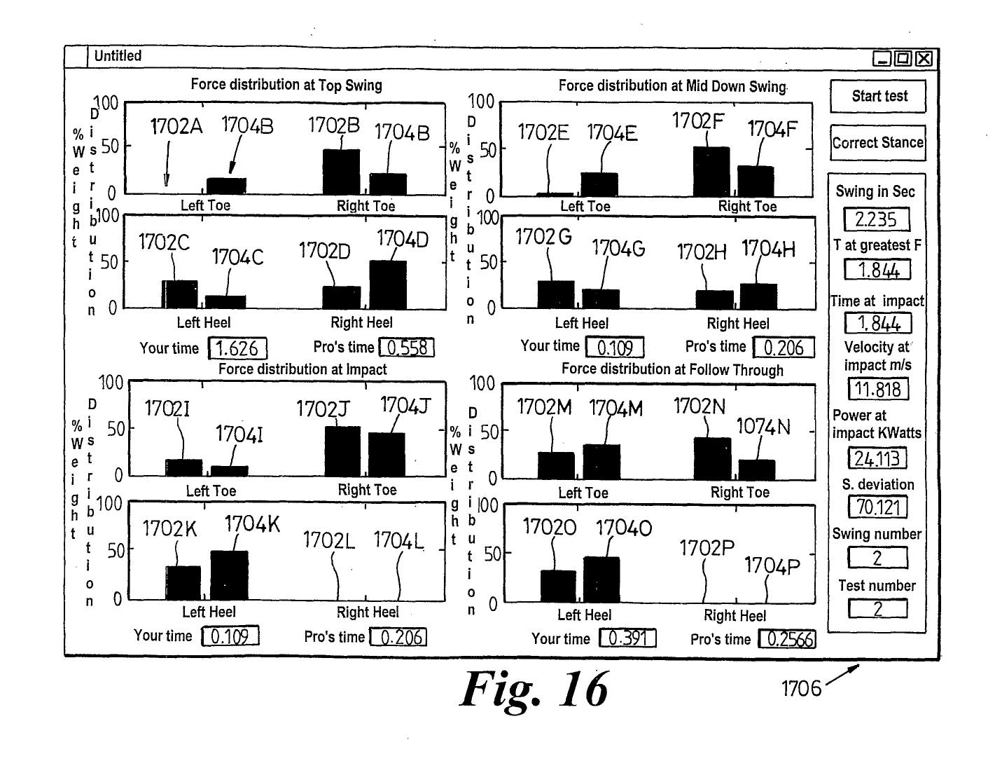

FIGS. 15 and 16 show example screen displays produced by an embodiment of the system.

An example of a data collection and processing system including a mat device (indicated generally at 102) intended to be used for producing data representing the actions of a golfer on the mat is shown in FIGS. 1 and 2. The mat includes a load-bearing surface 104 and a structure 106 for housing the surface 104. The surface 104 is at least partially covered by a layer of material 108. In the example the material 108 is Astroturf™, which gives the general impression of a typical golf driving range mat.

The load-bearing surface 104 can deform elastically under the influence of a loading stimulus. The load can be shear and/or bending forces. The shape and dimensions of the surface 104 can be any that will deform under load and its material properties will normally be selected according to the intended end use of the sensing system. The surface 104 can act as a single or multiple axes sensing face for the load.

The surface of the example system was designed using anthropometric data so that its dimensions accommodate a wide range of feet sizes, stance width and posture positioning for typical golf swings. The selection of type and thickness of the material used for the surface 104 is normally made with consideration of several factors, including sensing range; loading range expected, from anthropometrics (95^{th} percentile 95 kg); material robustness and elastic repeatability; required structural dimensions and/or aesthetic suitability.

In one embodiment the surface 104 and its housing structure 106 is formed of S275-43A steel and mild steel with a Young's modulus of 200 GPa, and a Poisson's ratio of 0.3. Typical dimensions of the surface 104 can be around 850 mm by 600 mm by about 4 mm to accommodate the anthropometrics of the body for the types of movement expected or alternatively a 850 mm by 600 mm by 6 mm for an aluminium Toplate C250, 5083 (NP8) alloy surface with a Young's Modulus of 70.3 GPa, and Poisson's ratio of 0.33 respectively. The dimensions of the surface 104 may be such that it can be integrated within existing golf range driving mats.

The surface can be designed through use of a Navier model expression or an FEA (Finite Element Analysis) approach using parameters of the expected measured stimulus. The Navier model is a known mathematical expression that can describe the magnitude of deformation at any point on the surface under any applied load in any position, relating to the material properties. It is also possible to manipulate Navier's model to define the required thickness of the surface material. This Will be on the basis that:
1) the required deformation of the surface is known, as to integrate adequately with the range of the sensing elements,
2) the expected loading characteristics are known
3) the required material properties and dimensions are also known.

The expression below can be used:

$$t = ( \sqrt[3]{( \frac{{\sum }_{a = 1}^{21} {\sum }_{b = 1}^{13} sin ( \frac{a \cdot π \cdot g}{e} ) \cdot sin ( \frac{b \cdot π \cdot g}{f} ) \cdot sin ( \frac{a \cdot π \cdot x}{e} ) \cdot sin ( \frac{b \cdot π \cdot y}{f} )}{{( \frac{{a}^{2}}{{e}^{2}} + \frac{{b}^{2}}{{f}^{2}} )}^{2}} )} ) \cdot \frac{48 W ( 1 - {v}^{2} )}{{π}^{4} \cdot e \cdot f \cdot E \cdot w ( x , y )}$$

where, (g, h) are the coordinates of the load, W is the load magnitude, (x,y) is the deformation point of interest, E, v, (e,f) is the Young's modulus, Poisson's ratio, and material dimensions respectively, and w is the value of the required deformation. In this case the example gave a material thickness of 4.2 mm, for steel of dimensions of (790'540)mm, with a maximum deformation of 5 mm for a stimulus of 150 kg placed in the centre of the plate. This was so that any deformations of the surface lie in the optimal range of the sensors for maximum sensitivity. Steel was selected because of its high shear, yield, bending stiffness and low hysteresis or high elastic repeatability. It is also robust, capable of withstanding repeated deformation and can be of low thickness, thus reducing weight, cost and height dimensionality. It will be understood that other material types and dimensions can be used.

Located within the sealed housing 106 is a plurality of sensors 202. There are various types of sensors that can be used in the system. These can be selected according to the desired limitations of the surface and construction for the particular intended application of the sensing system. The sensors may sense changes including changes in force, pressure, strain, capacitance, resistance inductance and/or optical characteristics, which can transform mechanical deformation in some way into an electrical output. In the example, the sensors are reflective optical sensors, also known as photo-interrupters. The resistance of these sensors changes as a function of light intensity, e.g. as a result of the distance between sensor and surface (reflector) changing. This change in resistance can be used to obtain a difference in voltage drop to produce a meaningful output relating to the deformation magnitude of the surface.

The selection of an appropriate set of sensors can be dependant on the sensitivity of the device upon the delivered mechanical stimulus and the supporting electronic circuitry 204 that enhances or transforms the response of the sensors into a suitable format. Examples of a supporting device 204 for the sensors include potential divider networks, amplifier circuits, spectral analyser circuits, or conditioning algorithms programmed onto microchips. The outputs of the selected device(s) will be compatible with a data capture device that can digitise the analogue data delivered by the sensing device(s) so that it can be processed further digitally through the means of a computer processor or microchip circuit. Sensors that produce output directly in digital form can also be used. An amplifier or conditioning circuit for tailoring the output of the sensors with the intention of providing maximum sensitivity and response may also be incorporated.

The number and positioning of the sensors with respect to the surface 104 can assist in the effective functioning of the system. As few as three sensors can provide useful results, but the actual/optimum number of elements in the system can be determined by various factors, including the deformation potential of the surface; the dimensions of the surface; the required robustness/reliability and/or the overall accuracy demanded by the user of the system. In the example system there are eight sensors 202 arranged in two parallel rows of four sensors. Adjacent pairs of the eight sensors are intended to sense stimuli (the loading at the feet) apparent on the surface which is effectively the sensing medium. However, it will be understood that different numbers of sensors could be used, e.g. 8 sensors has been found through analysis to be optimal for system output performance in one embodiment of the system. A benefit provided by this system compared with conventional sensing systems is that the number of sensors required is significantly reduced (compared with conventional array systems), which can result in reduced manufacturing costs.

The sensitivity, positioning and number of sensors under the surface 104 can be determined or selected using a derivation of the Navier model of plate deformation or any other mathematical model that can express the deformation of a surface under one or many loading conditions. In one case, the Navier model is manipulated to form a cost function for the appropriateness of the positions of the sensors, an example of which is described below.

The magnitude of deformation of a plate (q) at point (x,y) under a load of magnitude W_{q} at position (g,h) can be expressed as:

$$q ( x , y ) = {\sum }_{a = 1}^{∞} {\sum }_{b = 1}^{∞} [ \frac{sin ( \frac{a \cdot π \cdot g}{e} ) \cdot sin ( \frac{b \cdot π \cdot h}{f} ) \cdot sin ( \frac{a \cdot π \cdot x}{e} ) \cdot sin ( \frac{b \cdot π \cdot y}{f} )}{{( \frac{{a}^{2}}{{e}^{2}} + \frac{{b}^{2}}{{f}^{2}} )}^{2}} ] \cdot \frac{48 \cdot {W}_{w} \cdot ( 1 - {v}^{2} )}{{π}^{4} \cdot e \cdot f \cdot E \cdot {t}^{3}}$$

where (e), (f), and (t) are the length, width and thickness dimensions, respectively, of the surface 104, and (E) and (v) are the elastic modulus and poisons ratio, respectively, of the material used for the surface. The limits of a and b are selected as numerical values for the harmonics required in the model. In this case, the limit of a is selected optimally as 21 and the limit of b is selected as 13. This comes from a previous investigation to generate an algorithm result of the deformation to 2 decimal places in mm, into which the processing load and time is reduced.

The expression above describes the deformation of the surface 104 at any sensing element at co-ordinates (x,y) for any given point load W₁ at coordinates (g₁,h₁). If the deformation of the surface 104 under multiple load points is to be sensed then the magnitude of deformation (q) at sensing point (x, y) can be derived by the above expression and can then be added to another point load W₂ on the surface at point (g₂,h₂) at sensing point (x, y). These expressions can be added together for however many point loads that are to be investigated. Assuming that there are eight sensors under the surface, then the deformation at all eight points on the surface under the applied load(s) will be known. As the position of the eight sensing points are fixed, the position of the applied loads are known and their values in the expression are constant, but the load magnitudes on the surface will be dynamic or changing. For four point loads on the surface, the deformation at all sensing points can expressed as:

$$[ \begin{matrix}q ( {x}_{1} , {y}_{1} ) \\ q ( {x}_{2} , {y}_{2} ) \\ ⋮ \\ q ( {x}_{8} , {y}_{8} )\end{matrix} ] = [ \begin{matrix}{A}_{1} & {B}_{1} & {C}_{1} & {D}_{1} \\ {A}_{2} & {B}_{2} & {C}_{2} & {D}_{2} \\ ⋮ & ⋮ & ⋮ & ⋮ \\ {A}_{8} & {B}_{8} & {C}_{8} & {D}_{8}\end{matrix} ] \cdot [ \begin{matrix}{W}_{1} \\ {W}_{2} \\ {W}_{3} \\ {W}_{4}\end{matrix} ]$$

where A₁ in the above expression is a constant that represents the set values in the system as:

$${A}_{1} = {\sum }_{a = 1}^{∞} {\sum }_{b = 1}^{∞} [ \frac{sin ( \frac{a \cdot π \cdot {g}_{1}}{e} ) \cdot sin ( \frac{b \cdot π \cdot {h}_{1}}{f} ) \cdot sin ( \frac{a \cdot π \cdot {x}_{1}}{e} ) \cdot sin ( \frac{b \cdot π \cdot {y}_{1}}{f} )}{{( \frac{{a}^{2}}{{e}^{2}} + \frac{{b}^{2}}{{f}^{2}} )}^{2}} ] \cdot \frac{48 \cdot ( 1 - {v}^{2} )}{{π}^{4} \cdot e \cdot f \cdot E \cdot {t}^{3}}$$

The expression for C₂, for example, will be as follows (the skilled person will be able to derive the remaining expressions required):

$${C}_{2} = {\sum }_{a = 1}^{∞} {\sum }_{b = 1}^{∞} [ \frac{sin ( \frac{a \cdot π \cdot {g}_{3}}{e} ) \cdot sin ( \frac{b \cdot π \cdot {h}_{3}}{f} ) \cdot sin ( \frac{a \cdot π \cdot {x}_{2}}{e} ) \cdot sin ( \frac{b \cdot π \cdot {y}_{2}}{f} )}{{( \frac{{a}^{2}}{{e}^{2}} + \frac{{b}^{2}}{{f}^{2}} )}^{2}} ] \cdot \frac{48 \cdot ( 1 - {v}^{2} )}{{π}^{4} \cdot e \cdot f \cdot E \cdot {t}^{3}}$$

where all values in the above expressions and all other constant values from the multiplying matrix can be determined.

From this equation, the calculated magnitudes of the loads (W) in the known positions on the surface can be derived through a pseudo inverse multiplication of the constant matrix of values by the determined deformations from the sensors (q). The multiplication of the deformations in the (q) vector is multiplied by the inverse matrix. It is the condition of this pseudo inverse matrix that is of interest for determining the positions of the sensors. The condition of this inverse pseudo matrix can be determined by the ratio between the highest and lowest singular values that are numbers which are said to represent the contribution to the data in the matrix. If the ratio is small then the condition of the matrix is good, and thus good for a multiplication by the deformation matrix (q), to give an accurate description of the forces (W). The lower the condition number then the more equally sensitive the elements are under the surface, i.e. there are no dominant or recessive sensors and so the sensitivity of all sensors is of equal weighting. This calculation of the condition number (cost function value) will therefore change in relation to the position of the sensors and so the lower the condition number, the better suited the position of the sensors. This can be seen as a minimisation problem with an associated cost function with sixteen possible variables. This can be optimised (or near optimised) using a genetic algorithm that aims to find the lowest cost function through an optimal selection of sensory positions through a survival of the fittest process of generation and elimination.

The above method has been used to substantially optimise the cost function for positioning of the sensors in the example golf mat described above; however, there are other mathematical techniques that can be applied to optimise this or other cost functions relating to the surface integrated sensors. The exemplary method above can be applied to any type of sensors 202 under the surface 104 to select appropriate locations for them in the mat device 102. Examples of sensor locations (as determined by the genetic algorithm techniques discussed above) under the surface with sensory coordinates are given in FIG. 3.

The voltage output of the sensors 202 in the example is analogue in nature and is digitised through an ADC (Analogue to Digital Converter) in the support device 204, so that it can be used with a digital processor. The ADC can be configured by using a PIC18F2320 microcontroller and a serial communication driver (MAX2320). However, alternative ADC devices or other microchips can be used to perform this operation.

The power supply for the electronic components of the mat device 102 can to be supported using a 5V DC power supply and an AC/DC converter device that plugs into the mains supply. However, alternative power sources can be used, e.g. portable rechargeable lithium battery packs or power transmission from the USB communication cable between the devices.

The support device 204 transfers data representing the filtered output of the data to a digital computer 206 (see FIG. 2), having a processor 208 and memory 210. Memory 210 in the example includes software 212 that can be used to process the transferred data. The computer 206 is also connected to a display device 214.

The communication between the device 204 and the computer 206 in the example takes place by means of a serial interface, although it will be apparent that other forms of communication can be used, e.g. current/future USB, radio frequency (e.g. BlueTooth™), Firewire™, or infra red devices, for data sending between the devices. Data from the sensors may be collected during specific periods only, e.g. for around 5 seconds following an operator instructing the person on the mat to perform an action and simultaneously pressing a “start collecting data” buffon on the computer 208 (or another device), although data from the sensors could be monitored substantially continuously whilst the system is in operation.

The data transferred from the ADC to the computer 206 may be noise-prone due to poor electrical connections or power or circuitry problems in the system. In this case noise can be filtered from a signal to clean it up for further processing. The signal-processing algorithm normally benefits from clean, defined peaks and troughs in the time series as a control mechanism for decision-making and so it can be advantageous that potentially problematic ‘triggers’ in the noise are mitigated/eliminated. Examples of noise elimination techniques include the use of analogue and digital filters. Analogue filters techniques tend to be costly and so the system in the example uses mathematical digital filtering techniques. There are many digital filtering techniques that have been well documented, such as PCA/SVD, FFT/IFFT, Butterworth and other types of filters that are coefficient driven. It is the SVD (Singular Value Decomposition) approach that has been found to be one of the most effective for the filtration of noise from data to be transferred from the support device 204 of the golf mat device 102 in the example, as noise-orientated components that add little to the input signal are eliminated in the filtration process. It is also possible to incorporate a Butterworth digital real time filter directly onto the ADC device through the assembly coding of the denominator, and numerator coefficient multiplication on the device for captured real time samples within the period of the sampling frequency.

FIG. 4 illustrates schematically steps that can be performed by the software 212 (developed using, for example, the known Matlab (produced by The MathWorks of Natick, Mass.) or Visual C/C⁺⁺ programming environments). At step 402, the computer receives the filtered data transferred from the golf mat device 102. The data will normally be stored at least temporarily in the memory 210 (and/or possibly in an external storage device attached to the computer 206) and it will be understood that various data structures can be used for this purpose. The software 212 is intended to be used to obtain meaningful information regarding the stimulus on the surface 104 from the data. Thus, the software can interpret an array (having one or more dimensions) of time dependant data (dynamic sensory transients in the time domain) into a form that has a meaningful output relating to the condition of the load on the load-bearing surface 104.

At step 404, the software seeks to identify a portion of the received data that represents a period during which substantial changes in the loading on the surface 104 took place, e.g. whilst the person on the mat was performing a golf swing, so that data representing periods when no significant activity was taking place is not analysed for efficiency reasons. In the example a “windowing” technique (the steps of which are illustrated schematically in FIG. 6) is used for this purpose and outputs a fixed length vector, although it will be understood that other techniques could be used.

At step 406 the data to be analysed is characterised, i.e. it is put into or associated with a class that represents one or more certain characteristic(s) of the data. Steps 408 and 410 are intended to be performed after characterisation data has been produced. Typically, the data to be analysed selected at step 404 will be converted into a fixed length vector by the characterisation step 406 and this vector will be used in the classification process 408 (as represented schematically by the broken arrow from process 406 to process 408). However, other signal processing techniques, such as an interpolation of the selected (windowed) time series to normalise the variable length series into a fixed number of points, could be used. This can be done such that it is possible to generate a constant length input vector for the classification stage 408. Although this latter method may be considered as being comparatively crude, the input data to be analysed is directly fed into the classification process (as represented schematically by the arrow from process 404 to process 408) without being characterised directly beforehand, although some signal processing would normally also be required. The classification process 408 effectively attempts to match the data to be analysed with appropriate characterisation data to produce an indication of which class(es) most closely correspond to the sensed data. In the example, neural network techniques are used for this classification process. At step 410 an output representing the result of the classification step 408 is produced.

Two separate software packages may be used to implement step 406 and steps 408/410, or all these steps may be integrated into a single package. For instance, the characterisation step may be performed by software intended for use by a manufacturer or installer of the system who then provides another software package (including the characterisation data) to an end-user of the system that allows the user to use the system for classifying loads detected by the sensors in conjunction with the characterisation data. Alternatively, software that enables end-users to obtain their own data from the sensing system for characterisation, as well as classification may be made available.

FIG. 5 is a graph showing examples of data representing changes in voltages output by the sensors 208 over a period of time. For ease of illustration, only two data lines 502, 504 relating to data produced by two of the sensors is shown, but it will be understood that a process corresponding to the one described below can be applied to the output of all the sensors. In the example of FIG. 5, the point in time indicated by notional line 506 would normally define the “opening” of the window and the point in time indicated by notional line 508 would normally define the close point. As can be seen, the changes within the “window” defined by the two lines 506, 508 are significant compared with the data outside the window. Typically, during an activity to be monitored, there will be many changes in load during performance of the activity, with negligible changes occurring before the activity starts and after it finishes.

At step 602 of the windowing process of FIG. 6, the voltage values of the two data lines are summed together and the mean values are then calculated. At step 604 the windowing algorithm performs “polynomial filtering” and a “gradient search” by identifying + to − gradient changes in the mean voltage data that are greater than a particular threshold, which, for the example system, is set as twice the standard deviation. All such changes, along with the associated times on the graph, are added to a first list at step 606.

At step 608 − to + gradient changes in the mean voltage data that are greater than twice the standard deviation are identified. All such changes, along with the associated times on the graph, are added to a second list at step 610.

At step 612 the greatest voltage change values from each of the first and second lists are identified. At step 614 the two identified greatest changes are ordered chronologically so that the first-occurring greatest change is used to define the start/open window point (e.g. line 506 in FIG. 5) of the data portion to be analysed and the second-occurring greatest change is used to define the end/close window point (e.g. line 508 in FIG. 5) of the data portion. The actual start/open window point may be defined as a time a certain ms before the first identified change begins and, similarly, the actual end/close window point may be defined as a few ms after the second identified change. Variations to the steps shown in FIG. 6 that can be made but which would still achieve a similar result will be apparent to the skilled person, e.g. the data for each sensor could be analysed individually rather than using mean values.

FIG. 7 illustrates schematically an example of steps involved in the characterisation process 406. The example process involves a polynomial fitting algorithm that is intended to derive coefficients that reflect the profile of the data to be analysed. It has been found that a 30^{th} order polynomial function can effectively represent the profile of the data produced by the sensors. Thus, numbers representing 30 coefficients for a polynomial equation can be stored, from which data that accurately reflects the original information obtained by the sensors to a sufficient extent can be obtained. This data minimising approach requires less storage and so is more efficient than storing a greater amount of data representing all the readings taken by the sensors.

It will be understood that there are other ways of characterising time series data strings, such as probability density (histogram plots), coefficient extraction, Auto Correlation, Partial Correlation, FFT methods, PCA, SVD, and other time series variables such as ARMA (Auto-Regressive Moving Average) models that provide representative coefficients of the time series. The number of inputs in the vector can be of any number; however, generally, the more characterising inputs of the time series, the more accurate the data interpretation. On the other hand, the greater number of model inputs, the larger the network and the greater the number of training samples that need to be collected.

Typically, the number of training samples required for an effective neural network approach is roughly the number of inputs multiplied by the number of hidden nodes of the network (which is typically in the region of 1½ times the number of inputs), plus the number of hidden nodes multiplied by the number of output nodes. Thus, reducing the number of inputs will not only reduce the number of training samples required, but will also reduce the computational time needed to optimise and train the algorithm. It is also important to attempt to maximise the number of characterising coefficients, as this tends to lead to improved network performances. In order to provide a short fixed length number of inputs that can describe the profile of a variable length transient, various time series techniques can be applied to provide this function.

As outlined above, it is possible to produce a polynomial that describes the time series, which can be obtained at step 702 of FIG. 7. This polynomial can directly characterise the time series in both time and magnitude through a curve fitting process, similar to the methods applied for a regressive MLP (Multi-Layer Perceptron). The polynomial of the series of order s is given by a non-linear expression as:
Yₜ=a₁+a₂Xₜ+a₃Xₜ²a₄Xₜ³+ . . . aₛXₜ^{s}

The above expression can be described as a weighted non-linear sum of the time in the series with the addition of a starting constant when t=0. This method can be related to that of an ARMA model in some way, but does not encompass correlation through a memory in the series. For all observations in the series it is possible to develop an equation set and hence a representative matrix as:

$$[ \begin{matrix}{Y}_{1} \\ {Y}_{2} \\ ⋮ \\ {Y}_{N}\end{matrix} ] = [ \begin{matrix}1 & {X}_{1} & {X}_{1}^{2} & {X}_{1}^{3} & ⋯ & {X}_{1}^{s} \\ 1 & {X}_{2} & {X}_{2}^{2} & {X}_{2}^{3} & ⋯ & {X}_{2}^{s} \\ ⋮ & ⋮ & & & & ⋮ \\ 1 & {X}_{N} & {X}_{N}^{2} & {X}_{N}^{3} & ⋯ & {X}_{N}^{s}\end{matrix} ] \cdot [ \begin{matrix}{a}_{1} \\ {a}_{2} \\ {a}_{3} \\ {a}_{4} \\ ⋮ \\ {a}_{s + 1}\end{matrix} ]$$

From this it is possible to derive the polynomial coefficients through a pseudo inverse, or least squares approach. Again it is possible to define the optimal number of coefficients that characterise the series, through a minimisation of the error defined by:

$${\sum }_{i = 1}^{N} {\vert {\hat{Y}}_{i} - {Y}_{i} \vert}^{2} = {\sum }_{i = 1}^{N} {e}_{i} = e$$

At step 704 characterisation data based on the polynomial coefficients obtained is stored in the memory 210 of the computer 206 at least, although the data may be stored in or transmitted to another device. Thus, data effectively representing the outputs of the sensors as a time series has been created and stored, and this can be processed as a time series by the classification process 408. It will be appreciated that various data structures can be used for this step, but in the embodiment described, the data is suitable for use with the example neural network classification process described below.

Many methods can be used to formulate classification outputs relating to the input stimuli and the required output. These can be mathematical, linear, or non-linear. Inverse mathematical and linear evaluations tend to generate regressive output responses; however, these can be converted to generate classificatory outputs through the appliance of an additional algorithm to the regressive response.

For the selection of an appropriate classification process it is important to determine the possible classifications of the input data. Two dimensional inputs are easy to visually generalise. However, if there are more than two input dimensions, then these are difficult to visually perceive as required classifications. From this it would be difficult to strictly determine which approach would be optimal, thus both linear and non-linear classifications normally need to be analysed to determine the linearity of the dataset and correlation.

Single layer perceptron (SLP) neural networks implement the statistical techniques of linear regression and generalised linear models and can be applied to classification problems. Generalised linear models (GLM) consist of a linear combination of the input variables, the coefficients of which are -the parameters of the model, and an activation function approximate to the type of data being modelled. The training algorithms used for these types of models can include minimisation search algorithms such as steepest descent, conjugate gradient, or scaled conjugate gradient methods consisting of an iterated re-weighted least squares (IRLS) approach to formulate a relationship between given input and output patterns.

Resulting from the derived regressive output between input and output patterns, it is possible to generate a classificatory output response through the appliance of one of two possible activation functions. One of which is the logistic sigmoid functions involving multiple independent attributes given in the form:

$${y}_{j} = \frac{1}{1 + {ⅇ}^{- {a}_{j}}}$$

where αⱼ represents the developed regressive output from the SLP or MLP algorithm. This type of classification algorithm is designed to classify between one of two possible classes in the output vector i.e. if αⱼ<0 then the classification gives a value between 0<yⱼ<0.5, or if αⱼ≧0 then the classification gives a value between 0.5<yⱼ<1.

FIG. 8A shows examples of two data sets comprising a two dimensional input to one dimensional output. The diagrams represent how the input data is to be classified into either a first or second class. FIGS. 8A, 8 B and 9 (see below) can be seen in “Nabney I. T. (2002). Algorithms for Pattern recognition. Published by Springer-Verlag London Berlin Heidelberg”, a reference that visually describes the classification between two data sets comprising a two dimensional input to one dimensional output and are included herein for ease of understanding. FIG. 8B shows the classification boundary provided by the GLM and logistic activation function for various decision boundaries at 0.1, 0.5, and 0.9. On classifying the output as either a 1 or a 0, the method allows for additional flexibility through the decision boundaries. Normally this would be set to 0.5, i.e. if yj is greater than 0.5, then this would be rounded to the class 1, else this would be rounded to class 0. By incorporating a threshold parameter based upon the result of yⱼ then this allows for a biasing of the output, which could, when analysed, enhance the system performance.

Another common linear classifying function is known as the “softmax” function. Its operation is similar to that of the logistic function with respect to the derived regressive response αⱼ to give classification yⱼ. It functions on the basis of a set of c mutually exclusive classes and is given in the form:

$${y}_{j} = \frac{{ⅇ}^{{a}_{j}}}{{\sum }_{{j}^{′}} {a}_{{j}^{′}}}$$

This function can be used for multiple classifications from the regressive SLP, or MLP.

Softmax or logistic sigmoid classification activation functions can also be applied to the regressive result of multi layered perceptron (MLP) neural networks to generate non-linear classifications due to the non-linear regressive output response from the correlation between input and output through the MLP. These can be compared with linear boundary classifications using a GLM regressive approach.

FIG. 9 shows examples of non-linear classification boundaries with different threshold decisions from a logistic activation function through an MLP regressive response.

The collection of the “training” characterisation data can be accomplished by the use of a loading stimulus table. An example of such a table intended to simulate loads produced by left and right human feet (e.g. for acquiring data relating to sporting activities) is shown in FIG. 10. The table 1000 is typically used during manufacture or configuration of the sensing system to automatically acquire sensory data from an applied stimulus. The table 1000 includes at least four loading points to simulate the forces at the heel and ball locations of a pair of human feet. The loading points may be moved by hydraulic or pneumatic means, for example. In the case of the table 1000, a set of four linear actuators 1002A-1002D is coupled to four respective load cells 1004A-1004D that can measure an applied load. These components are supported by a frame 1006. The linear actuators 1002 and load cells 1004 can be positioned where stimulus is expected on the surface 104 (through the layer of Astroturf 108) and the table allows the movement in x and y directions. A controlling mechanism 1008 drives the actuators 1002 to a desired position and collects data representing the load measured by the load cells 1004.

The controlling mechanism 1008 is driven by software (which may be part of the software 212 running on a computer in communication with the table 1000, for example) that reads the load cell measurements and compares them with the defined required stimulus, until the positions of all the actuators 1002 correspond to what is required for that particular loading data set. When this is achieved, the data output by the sensors 202 is recorded by the program along with the specific loading condition. This can be repeated for any number of required loading samples. Thus, load data and the corresponding measured outputs of the sensors on the surface that can define the linear or non-linear transformations of the input to the output can be generated. An MLP method could be used in a similar way to generate data describing the positioning of feet on the surface from the collected data set at all possible positions on the surface.

Specific examples of processes performed by embodiments of the system concerned with collecting and/or analysing data relating to golfing activities will now be described.

FIG. 11 shows filtered sensor data relating to the force distribution at the toes and heels of the feet of an 85 kg professional golf player performing a full swing on the surface 104 as obtained as a result of steps 402 and 404, for example. From this data, more information can be derived about the golf swing.

When an MLP process is used, the vector of sensor data to be analysed is multiplied through by (and added to) the trained weights and biases from the trained empirical data (e.g. obtained using the table 1000) to produce an output relating to that unique time sample input. This vector of sensor data is fed into a MLP neural network to formulate a position and load magnitude. The load position and magnitude in this case gave a total system error of around 5.2% and 0.5% respectively.

It is possible to classify frequency through the use of DFT/FFT, velocity, or cadence, and verify the output with a motion tracking system. Using linear time series methods it is possible to classify the time series data into meaningful outputs. It was found that from the analysis of a right-handed professional golfer performing a golf swing; that the reaction force on the left toe reaches a peak when the golf shot was made, and also at the same point in time the loading on the left heel falls to zero. This relationship had been verified by video evidence taken from the golf player during the swing. It has also been noted that the trough before the peak at the left toe indicates the top of the back swing and the trough after the peak on the left toe indicates the point at the top swing. The first few points in the time series show the golfer at the stance position. From this, linear gradient methods can be used to define the time and weight distribution of the feet at these key points in the swing.

From this understanding of the data in the window it is possible to segregate the time series as follows, for example: Stance posture and position; Stance to Top of the back swing; Top of back swing; Top of the back swing to impact and Impact to Top of the follow through.

Many possible flaws can be identified within these regions and can be determined through the analysis of the forces during that particular time phase, such as:
1) Stance posture and position (e.g. Posture at address; Misalignment of the body at address; Stance width)
2) Stance to Top of the back swing (e.g. Picking up the club too abruptly; Clubhead moves inside too quickly; Taking the clubface back closed; Flat laid-off backswing; Body turn completed too early; Taking the standing heel of the surface during the backswing)
3) Top of back swing (e.g. Reverse hip tilt; Incomplete body turn; Out of position right knee; Reverse pivot/poor weight transfer; Over swinging; Wrong plane—too upright or too flat)
4) Top of the back swing to Impact (e.g. Hitting from the top—violent change of direction; Over the top—club jammed to body; Poor weight transfer; Early release of the clubhead)
5) Impact to Follow through (e.g. Leg overdrive; Dominant left side/poor body release; No extension past impact; Poor follow through position)
6) Other flaws (e.g. Excessive head movement; Arms and body out of sync/poor timing; Too quick, too slow, poor tempo; Jerky swing—lack of rhythm; Loosing your balance/poor footwork; Other flaws associated with putting, chipping and pitching)

In the example system, taking poor weight transfer in the downswing as an example, producing a classification as a percentage score or as a simple good or bad indication can be achieved through various methods including: a) an MLP classifier, and a characterising coefficient derivation approach, and b) Kullback Leibler divergence method of classification. It will be appreciated that other methods, such as a Radial Basis method or a Baysian techniques could be used. Examples of methods a) and b) will now be described:

a) MLP Classifier and Characterising Coefficient Derivation Approach

FIG. 12 demonstrates the time series for the downswing as sensed by all eight sensors 202. This can be used in the characterisation process of the time series. However, it is also possible to use the force descriptors derived by the static SLP method for characterisation of the data of FIG. 11. Using all of the sensory data for a characterisation, as opposed to the force descriptors, is found to be more effective as there is much more information in the sensory data. The sensory data can be normalised through time and magnitude so that each time series has equal weighting and is added as a set to form one time series. From this a line of best fit can be drawn through the coupled response. Taking 1000 points at equal intervals the difference between the actual value and the line of best fit can be calculated to form a vector of 1000 differences. From this vector the highest, lowest, mean, standard deviation, root mean square, variance, and sum can be taken as the characterisation coefficients for the input vector of the transient as a few data values. The characterisation process can normalise and minimise the number of inputs applied to the network so as to reduce the number of training samples required.

b) Kullback Leibler (KL) Divergence Method of Classification

This method can be used as a classification tool to determine how far from the ideal a specific flaw in the swing is. For example, if it is to be assumed that a professional golfer has ideal weight shift in the down swing, then it is possible to characterise the sum of the sensory normalised transients into a normalised integral, probability densities, which are derived from a combination of the forces shown in FIG. 11, as illustrated in the graph of FIG. 13. Each degree of swing for poor weight shift will therefore have its own unique probability density plot. It is then the comparison of this with the ideal probability density function that can be classified as a divergence from the ideal density function. The divergence or distance between the two time series can be calculated through the use of the Kullback Leibler divergence method below:

If the difference of the expression is zero then the two time series or histograms are identical, the larger the value derived from the expression then the less it matches with the ideal time series. Thus, this value can be used as a classification value for a good or bad movement without the use of an MLP. KL(q, p)≧0 Measures the ‘difference’ between distributions p and q.

Assuming that distribution q relates to an ideal weight shift in the downswing, and distribution p relates to a non-ideal weight shift in the down swing. Then the distance or entropy is given as:

$$K L ( q , p ) = {\sum }_{i = 1}^{n} {q}_{i} * ln ( \frac{{q}_{i}}{{p}_{i}} )$$

Thus, the distance KL relates to the time series similarity and can be expressed as a percentage, and n is the number of samples in the time series. Therefore, a distance or percentage of similarity can be used as a classification tool to the similarity between an amateur and professional golfer for various flaws in the golf swing. Thus, advice can be given on the performance of the many flaws indicated after the golf swing has been completed.

In one experiment, eight sets of data to be analysed for each individual class of backswing for investigating three possible flaws (given in the table below) were captured using the mat device 102 for classification.

| Swing No. | Legs/knees flexed | Left heel planted | Correct orbit angle |
|---|---|---|---|
| 1 | Yes | Yes | Yes |
| 2 | Yes | Yes | No |
| 3 | Yes | No | No |
| 4 | No | No | No |
| 5 | No | Yes | Yes |
| 6 | No | No | Yes |
| 7 | No | Yes | No |
| 8 | Yes | No | Yes |

Reducing the number of describing classes has been found to enhance system performance. For example, assuming that a swing is to be classified as one of eight possible classes, then a random selection process would give accuracies of only 12.5%. If, on the other hand, the classification process was only between two classes then a random process would give results of 50%. Therefore problem is split down into various sub-classes, so that the number of possible classes are reduced from eight down to two.

FIG. 14 shows the same set of data 1502 to be analysed being passed to three different classification algorithms 1504A-1504C, each of which can produce a Yes/No response 1506A-1506C indicating whether or not the data input matches that class. A breakdown of the problem into two classes from eight increases the number of possible input patterns in that class from 18 to 72. For example, this is a result of a classification of all swings in the total data set that have the knees flexed verses all of the swings in the set without the knees flexed, regardless of what other motions are being performed during the backswing.

The output produced at step 410 may include sounds, graphs, text, symbols and/or other graphics. Alternatively, the output may be in machine-readable format for transfer to another device for subsequent use. Human-readable output may be displayed through any form of display. In the example, the monitor/screen 214 is used to display the output graphically. Output/feedback data for the user can include information relating to: Balance at stance plots (FIG. 15) and/or Numeric evaluation and visual comparison (FIG. 16); Classification of movement feedback; Visual Swing signatures, and body movement; Monitoring of previous performance, through database methods; Print outs, of current and previous performances. However, other abbreviations and measurement feedback techniques can be used by the system.

The example display of FIG. 15 illustrates the actual distribution of mass (indicated by cross 1602) of the golfer during the swing ‘set up’, as obtained from data produced by the mat device 102. The ‘ideal’ distribution of mass is represented by circle 1604. As the golfer modifies the distribution of his/her mass during set up, the cross will move accordingly. When the cross is located in the circle, the ‘ideal’ stance has been achieved.

In the example display of FIG. 16, the (left-hand) bars 1702A-1702P represent the user and the (right-hand) bars 1704A-1704P represent the ‘ideal’ distribution of mass throughout the key points of the golf swing. The column 1706 on the right indicates certain statistics of the swing, such as consistency between swings (standard deviation) and velocity of club head at impact.

This analysis of golf swings can be used as a monitoring tool and to provide a substantially instantaneous prognosis so that the user can learn and enhance his/her performance. It will be understood that embodiments of the system can be used to collect and interpret data representing dynamic forces in other contexts. Relating the functions to an application for the classification of various Golf swings is used herein as an example application; however, some or all of these functions can also be used to solve various other applications that observe a dynamic time dependant input signal, including analysing the movements of players of other sports. Examples of other applications in the sporting area include classification of tennis, squash and badminton swings; classification of cricket strokes; classification of ski technique; classification of running technique; classification of kinetic movement for javelin, discus or hammer throwing; classification of weight lifting stance and technique; classification of aerobics movements; classification of the balance on the stirrup and saddle for horse riding; or any other application pertaining to sport and/or exercise.

1. A method of processing data including steps of:
obtaining data describing deformation of a plurality of discrete points of a surface over a period of time, and
processing the obtained data as a time series to:
produce characterisation data describing characteristics of the deformation of the surface over a period of time, and/or classify the obtained data according to one or more of a set of characterisation data describing characteristics of deformation of the surface over a period of time.

2. A method according to claim 1, wherein the step of producing the characterisation data includes calculating coefficients for an equation that substantially reproduces the obtained data, and storing data describing the coefficients for use in the classification step.

3. A method according to claim 1, wherein the step of classifying the obtained data includes comparing the obtained data with a said set of characterisation data, and selecting the member or members of the set that most closely matches the obtained data.

4. A method according to claim 3, wherein the comparison is performed using linear or non-linear neural network classification techniques, or a divergence method, or a linear matrix inverse method.

5. A method according to claim 4, wherein the classification step includes inputting data to be analysed into a neural network that has been trained to classify data according to one or more of a set of data describing characteristics of the kinematical movement or deformation of the surface.

6. A method according to claim 1, wherein the classifying step includes a linear classification process when there is a linear relationship between the obtained data that is used as an input for the linear process, and an output of the linear process, or a non-linear classification process when there is a non-linear relationship between the obtained data that is used as an input for the non-linear process and an output of the non-linear process.

7. A method according to claim 6, wherein the linear classification process includes using generalised linear models (GLM) or single layer perceptron (SLP) neural networks to compare the obtained data, with one of the set of characterisation (or other input data) to produce a con-elation indication to give a regressive response and/or applying an activation function to the regressive correlation indication to produce a classification output.

8. A method according to claim 6, wherein the non-linear classification process includes using a multi layer perceptron (MLP) network, Radial Basis Function (RBF) network, or a Baysian technique to compare the obtained data with one of the set of characterisation data to produce a correlation indication to give a regressive response and/or applying an activation function to the regressive correlation indication to produce a classification output.

9. A method according to claim 1, further including a step of identifying a portion of the obtained data to be analysed, where the data to be analysed represents a time period during which there were changes in the surface deformation.

10. A method according to claim 9, wherein the portion of the obtained data to be analysed is identified using a windowing technique that searches for + to − and − to + gradient changes that are greater than two times the standard deviation of the data and uses the greatest of each of the + to − and to + changes found to define the open and close points of the data window.

11. A method according to claim 1, wherein the obtained data represents forces and/or loads on the surface that cause the surface to deform, the method further including a step of producing data describing a position, stance, movement(s) and/or dynamic behaviour of a body acting on the surface.

12. A method according to claim 1, further including a step of producing an output representing the result of the classification step.

13. A method according to claim 12, wherein the characterisation data represents a “target” for data in that class and the output includes a comparison of data derived from the obtained data with data derived from the characterisation data that classified the obtained data.

14. A method according to claim 13, wherein the output includes a representation of a target stance and a representation of a stance of the user derived from the obtained data.

15. A method according to claim 13, wherein the output includes a representation of target distribution of mass and a representation of distribution of mass of the user derived from the obtained data.

16. A method according to claim 13, wherein the representations of the output are divided according to time/events, key points of a golf swing.

17. A computer program product comprising:
a computer usable medium having computer readable program code and computer readable system code embodied on said medium for processing data, said computer program product including:
computer program code means, when the program code is loaded, to make the computer execute a procedure to:
obtain data describing deformation of a plurality of discrete points of a surface over a period of time, and
process the obtained data as a time series to:
produce characterisation data describing characteristics of the deformation over a period of time, and/or classify the obtained data according to one or more of a set of characterisation data describing characteristics of deformation of the surface over a period of time.

18. A system for collecting and processing data including:
a device for producing output data describing deformation of a surface
a device for obtaining data describing deformation of discrete points of the surface over a period of time, and
a device configured to process the obtained data as a time series to: produce characterisation data describing characteristics of the deformation of the surface over a period of time, and/or classify the obtained data according to one or more of a set of characterisation data describing characteristics of deformation of the surface over a period of time.

19. A system according to claim 18, wherein the device for producing the characterisation data includes a plurality of sensors located adjacent the surface.

20. A system according to claim 19, wherein the device for producing the characterisation data further includes one or more devices for amplifying and/or filtering the outputs of the sensors.

21. A system according to claim 18, wherein the system includes four groups of the sensors, the sensor groups being intended to sense stimuli from a ball area of a first foot, a heel area of the first foot, a ball area of a second foot and a heel area of the second foot, respectively.

22. A system according to any one of claims 19, wherein the positions and/or the number of the sensors are selected such the output of none of the sensors has an unduly dominant influence on calculations performed by the system.

23. A system according to claim 22, wherein the positions/number of the sensors with respect to the surface are selected by:
calculating a cost function value describing the accuracy of each of the sensors in sensing deformation of the surface, the cost function involving values representing the number and/or locations of the sensors and properties of the surface, and
selecting the locations of the sensors in accordance with the resulting best cost function values.

24. A system according to claim 23, wherein a genetic algorithm technique is used to determine the best cost function values.

25. A system according to claim 23, wherein the cost function involves the Navier Model.

26. A system according to claim 18, wherein the surface is formed of a deformable material with low levels of hysteres˜is, such as a metal/alloy, steel or aluminium.

27. A system according to claim 18, wherein the device for producing data further includes a housing (106) for the sensors and the surface and wherein a covering is fitted on top of the surface to alter its appearance and/or texture.

28. A system according to anyone of claims 18, further including a device for simulating one or more loads produced by other bodies on the surface.

29. Apparatus for processing data including:
a device for obtaining data describing-deformation of discrete points of a surface over a period of time, and
a device configured to process the obtained data as a time series to:
produce characterisation data describing characteristics of the deformation of the surface over a period of time, and/or classify the obtained data according to one or more of a set of characterisation data describing characteristics of deformation of the surface over a period of time.

30. A device for producing data describing deformation of a surface suitable for use in connection with data processing apparatus according to claim 29.

31. A method of training a neural network to classify data describing deformation of a surface, the method including steps of:
obtaining a set of data describing deformation of a plurality of discrete points of a surface over a period of time;
training a neural network to identify characterisation data that corresponds to surface deformation having certain characteristics using the obtained data, and storing the neural network in a storage means of a computer or on a computer-readable medium.

32. A neural network system trained to classify data describing deformation of a surface substantially according to claim 31.

33. A sports training system including:
a device for producing output data describing deformation of a plurality
